(19) United States
(12) Patent Application Publication
(10) Pub. No.: US 2005/0232470 A1
(43) Pub. Date: Oct. 20, 2005

(54) Method and apparatus for determining the identity of a user by narrowing down from user groups

(75) Inventors: Upendra V. Chaudhari, Briarcliff Manor, NY (US); Jiri Navratil, White Plains, NY (US); Jason W. Pelecanos, Ossining, NY (US); Ganesh N. Ramaswamy, Ossining, NY (US); Ran D. Zilca, Briarcliff Manor, NY (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 10/813,709

(22) Filed: Mar. 31, 2004

(51) Int. Cl. G06K 9/00

(52) U.S. Cl. 382/115

(57) ABSTRACT

Methods and arrangements for assessing the identity of an individual. Input is accepted from an individual, and at least one user group is attributed to the individual. This attributing is repeated until the identity of the individual is assessed.

### FIELD OF THE INVENTION

The present invention generally relates to user authentication and identification methods, i.e. methods and apparatus for determining the identity of a user. The present invention specifically relates to systems that recognize the identity of a user given a biometric sample such as voice, fingerprint, hand geometry, iris, etc.

### BACKGROUND OF THE INVENTION

Current solutions to problems of the type just describe use one or more of the following authentication/identification methods: possessing an id-device (e.g. door key), knowing a certain piece of knowledge (e.g. passwords), and biometrics (e.g. voice print). Biometrics have the advantageous property of using an inherent attribute of the user (e.g. a fingerprint). Biometric systems perform user authentication and/or identification. For example, a speaker verification system determines the identity of a person given their speech sample. Unlike some other types of biometrics such as fingerprint recognition (referred to as static biometrics herein), the more a person speaks, the better the voice can be characterized and hence the higher the accuracy of the speaker recognition system; biometrics that have this property are referred to herein as dynamic biometrics. Some examples of static biometrics are: fingerprint, iris, retina, and hand geometry, while examples of dynamic biometrics include voice, gait, and keyboard stroke.

Dynamic biometrics systems such as speaker recognition systems exhibit reduced accuracy when less biometric data is available (for example when the user does not speak much). Therefore, such systems will typically try to elicit more data from the user, which is impractical in some applications. Whenever there is not enough data to make an accurate identity decision, current dynamic biometrics systems may simply fail to determine who the user is, without providing additional information that may characterize the user even without knowing her/his identity.

A need therefore has been recognized in connection with providing dynamic biometrics systems that improve upon the shortcomings of the efforts made to date.

### SUMMARY OF THE INVENTION

There is broadly contemplated, in accordance with at least one preferred embodiment of the present invention, the performance an authentication/identification task by narrowing down the possible class of user identities, in a refined fashion, as the user speaks, walks, types or performs some other function. For example, for a certain speaker recognition system 20 seconds of speech data might be required to accurately determine who the speaker is. However, it is recognized herein that, e.g., after 2 seconds it is distinctly possible to accurately determine that the user is a female, and after an additional 5 seconds determine that it's a female in her 30's, after 6 more seconds determine that she has a southern accent, etc. In this way the system gradually narrows down the user's identity subset. Such an approach can represent part of a holistic user profiling system that is able to provide information about the user in an incrementally refined manner. It also permits a user to be recognized to some degree without the requirement of explicitly enrolling a model or template from the user's reference biometrics. Hence, low security transaction and related applications could be enabled through basic user profiling checks on the user.

In at least one preferred embodiment of the present invention, two components are used in concert:
1. A method/apparatus to characterize a user by his/her level of match with predetermined user groups (male/female, accent, age, fast walkers, slow walkers, voice quality, voice thickness, roughness, softness, speaking style). This is referred to herein as a user profiler.
2. A method/apparatus to compute a confidence measure reflecting how confident the system is that the user belongs to a particular user group (e.g. a measure representing how confident the system is that a speaker is a male speaker). This is referred to herein as a confidence estimator.

The user profiler and the confidence estimator preferably use user-group models to determine their output vectors. For example, the user profiler may use user-group models trained on subsets of the user population such as: male, female, hoarse-voice, slow walkers, etc. Both the profiler and confidence estimator preferably operate as biometric data is being collected (i.e. as the user speaks/walks/types), and allow the user to be authenticated/verified in a “narrow down” process. In this process, the system gradually determines confidently that the user belongs to additional groups, until it potentially determines confidently who the user is. The process can be likened to an application of successive sieves that filter speaker characteristics with increasing precision.

In summary, one aspect of the present invention provides a method for assessing the identity of an individual, said method comprising the steps of: accepting input from an individual; attributing at least one user group to the individual; and repeating said attributing step until the identity of the individual is assessed.

An additional aspect of the present invention provides an apparatus for assessing the identity of an individual, said apparatus comprising: an arrangement for accepting input from an individual; and an arrangement for attributing at least one user group to the individual; said attributing arrangement being adapted to repeat the attributing until the identity of the individual is assessed.

Furthermore, another aspect of the present invention provides a program storage device readable by machine, tangibly embodying a program of instructions executable by the machine to perform method steps for assessing the identity of an individual, said method comprising the steps of: accepting input from an individual; attributing at least one user group to the individual; and repeating said attributing step until the identity of the individual is assessed.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a schematic block diagram of primary components in accordance with an embodiment of the present invention.

FIG. 2 is essentially the same diagram as FIG. 1 but illustrating an additional step.

FIG. 3 is a schematic block diagram depicting a second enrollment method.

### DESCRIPTION OF THE PREFERRED EMBODIMENTS

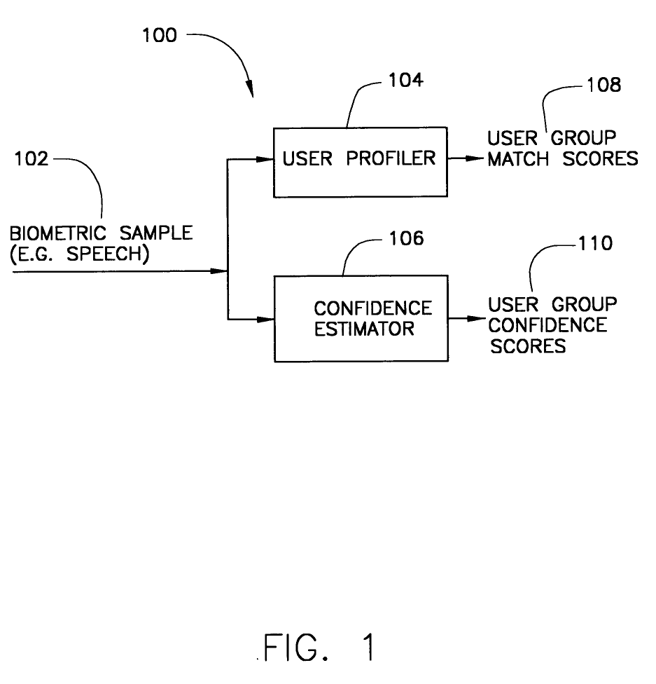

FIG. 1 illustrates a system 100 configured in accordance with a preferred embodiment of the present invention. A user's biometric sample 102 (such as speech) is preferably input and fed to a user profiler 104 and confidence estimator 106, as described further above. A user.7s group match scores 108 and group confidence scores 110, respectively, are preferably provided as output.

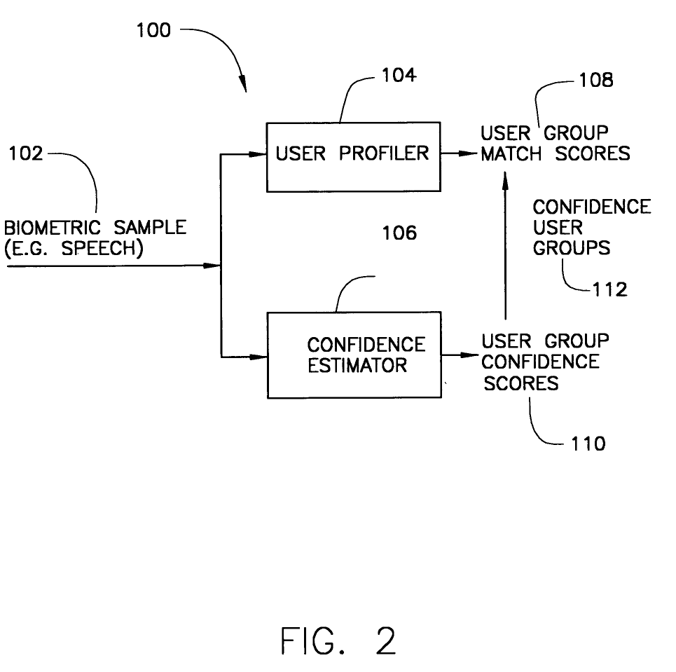

Preferably, a speaker may enroll in the system in one of two ways. As one possible measure, the user may provide biometric data (e.g. speak) while both the profiler 104 and confidence estimator 106 are operating. Once enough confidence measures are met, there then will develop an indication that the user belongs to the corresponding user groups. The match levels for the confident groups, represented by a vector of profiler scores, then serve as the user's model/template that will be used as a reference when the user's identity needs to be determined in the future. This is referred to as enrollment method 1 herein. FIG. 2 schematically illustrates this method; it essentially is the same illustration as FIG. 1 but shows an additional feed of confident user groups 112 between user confidence scores 110 and user group match scores 108.

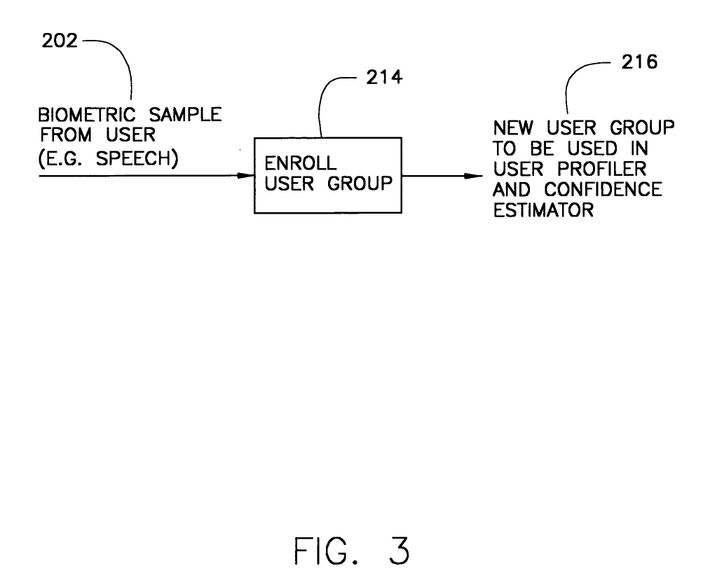

As another possible measure, a profiler may be enhanced to include an additional group which includes only the user. When this method is used, user enrollment involves the same procedures that are used to enroll a user-group in the profiler and confidence estimator. This is referred to as enrollment method 2 herein, and is illustrated in FIG. 3. Thus, with a biometric sample 202, a user group may be enrolled (214) at which point the resulting new user group 216 could be used in a user profiler 104 or confidence estimator a 106 as in FIG. 1.

Generally, referring back to FIG. 1, when a user needs to be authenticated or identified, the user speaks/walks/types, the profiler 104 operates in an ongoing manner, and thus issues group-match scores 108. In parallel, the confidence estimator 106 issues group-confidence scores 110. Once a given confidence measure meets a threshold, the user is deemed to belong to the corresponding user group. The system then preferably issues a cue. The identity determination process (either authentication or identification) is thus preferably released as a series of cues over time. When sufficient data is available, the final cue may be the user's identity. The cues can make use of essentially information conveyed in the biometric signal. For speech, this may be acoustic/spectral information, words, content, emotional cues, etc.

The embodiments of the present invention may be used for both user identification and authentication. For user identification, an example of returned cues during the time that a user speaks might be:
<male><between 25 and 45 years old><Has foreign accent><Breathy voice><nervous><likely to have college education><polite><speaks fast><John Smith>

For user authentication, with a target speaker class of “John Smith”, an example of returned cues during the time the user speaks might be:
<Indeed a male><Age range found to match John's age><has breathy voice like John><It is John>

Or:
<female=NOT John>.

If the user enrolled using enrollment method 1, then authentication may be performed in the following way. Once the user provides enough biometric data such that all of the groups she/he belongs to are confident (meet the confidence thresholds), a similarity score is computed as a distance measure between the vector of profiler match scores during authentication and during enrollment. This score is then thresholded to decide whether to accept the user's identity claim or reject it. Similarly, for user identification the system preferably computes profiler and confidence scores for all enrolled users. Once a confident profiler vector is obtained with respect to all enrolled users, and once the profiler vector of the test biometrics meets the confidence thresholds, the user's identity is determined to be the one corresponding to the user for which the distance measure between the test biometrics' profiler vector and the user vector is the smallest.

If the user enrolled using enrollment method 2, then authentication may be performed in the following way. Once the confidence score of the user model meets a threshold, a user authentication decision can be made by thresholding the score that the profiler produced for the user model. If the session ends prior to confident authentication of the user model, the partial confident information obtained for other models can be used.

Though enrollment methods 1 and 2 have been described hereinabove individually, it is certainly the case that a combination of both methods may also be used.

Though the manners and algorithms that could be employed for carrying out the embodiments of the present invention as described above are potentially vast, the algorithms described and contemplated in the following references have been found to be particularly meaningful in connection with different aspects of the present invention: for statistical modeling and Gaussian Mixture Models (GMM), G. N. Ramaswamy, J. Navratil, U. V. Chaudhari, R. D. Zilca, “The IBM system for the NIST 2002 cellular speaker verification evaluation,” ICASSP-2003, Hong Kong, Apr., 2003; and for discriminative methods such as Support Vector Machines (SVM), S. Fine, J. Navratil, R. A. Gopinath, “A hybrid GMM/SVM approach to speaker Identification,” ICASSP 2001, Salt Lake City, Utah, May 2001. The methods described in these two references are currently used to enroll user models in biometric systems, but can be used as-is to enroll user groups, simply by feeding the enrollment method with biometric data exclusively from a group of users instead of from a single user.

It is to be understood that the present invention, in accordance with at least one presently preferred embodiment, includes an arrangement for accepting input from an individual and an arrangement for attributing at least one user group to the individual. Together, these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A method for assessing the identity of an individual, said method comprising the steps of:
accepting input from an individual;
attributing at least one user group to the individual; and
repeating said attributing step until the identity of the individual is assessed.

2. The method according to claim 1, wherein said repeating step comprises repeating said attributing step until the identity of the individual is determined.

3. The method according to claim 2, wherein said step of repeating said attributing step until the identity of the individual is determined comprises performing a gradual determination of the identity of the individual via issuing a stream of cues over time, each of said cues being indicative of one or more user groups to which the individual belongs with a given degree of confidence.

4. The method according to claim 2, wherein said step of repeating said attributing step until the identity of the individual is determined comprises performing a partial determination of the identity of the individual via issuing a stream of cues over time, each of said cues being indicative of one or more user groups to which the individual belongs with a given degree of confidence.

5. The method according to claim 2, wherein said repeating step comprises attributing to the individual at least one user group that is distinct from any user group previously attributed.

6. The method according to claim 5, whereby the individual is identified by narrowing down a quantity of possible individuals into smaller user groups.

7. The method according to claim 1, wherein said attributing step comprises characterizing the identity of an individual as a vector of similarity scores with respect to given user groups.

8. The method according to claim 1, wherein said repeating step comprises repeating said attributing step until the identity of the individual is authenticated.

9. The method according to claim 8, wherein said step of repeating said attributing step until the identity of the individual is authenticated comprises performing a gradual authentication of an identity claim of the individual via issuing a stream of cues over time, each of said cues being indicative of one or more user groups to which the individual belongs with a given degree of confidence.

10. The method according to claim 8, wherein said step of repeating said attributing step until the identity of the individual is authenticated comprises performing a partial authentication of an identity claim of the individual via issuing a stream of cues over time, each of said cues being indicative of one or more user groups to which the individual belongs with a given degree of confidence.

11. The method according to claim 1, wherein said repeating step comprises performing at least a partial assessment of the identity of the individual via issuing a stream of cues over time, each of said cues being indicative of one or more user groups to which the individual belongs with a given degree of confidence.

12. The method according to claim 11, wherein:
said repeating step further comprises the step of performing real time data retrieval; and
said step of performing real time data retrieval comprises employing the issued cues to narrow down a database to be searched.

13. The method according to claim 11, wherein:
said repeating step further comprises the step of performing real time discovery of the individual; and
said step of performing real time discovering comprises employing the issued cues to narrow down user models which represent potential users to be scored.

14. The method according to claim 11, wherein:
said repeating step further comprises the step of performing real time authentication of the individual; and
said step of performing real time authentication comprises employing the issued cues to narrow down relevant imposter models which represent potential false users.

15. An apparatus for assessing the identity of an individual, said apparatus comprising:
an arrangement for accepting input from an individual; and
an arrangement for attributing at least one user group to the individual;
said attributing arrangement being adapted to repeat the attributing until the identity of the individual is assessed.

16. The apparatus according to claim 1, wherein said attributing arrangement is adapted to repeat the attributing until the identity of the individual is determined.

17. The apparatus according to claim 16, wherein said attributing arrangement is adapted to perform a gradual determination of the identity of the individual via issuing a stream of cues over time, each of said cues being indicative of one or more user groups to which the individual belongs with a given degree of confidence.

18. The apparatus according to claim 16, wherein said attributing arrangement is adapted to perform a partial determination of the identity of the individual via issuing a stream of cues over time, each of said cues being indicative of one or more user groups to which the individual belongs with a given degree of confidence.

19. The apparatus according to claim 16, wherein said attributing arrangement is adapted to attribute to the individual at least one user group that is distinct from any user group previously attributed.

20. The apparatus according to claim 19, whereby the individual is identified by narrowing down a quantity of possible individuals into smaller user groups.

21. The apparatus according to claim 15, wherein said attributing arrangement is adapted to characterize the identity of an individual as a vector of similarity scores with respect to given user groups.

22. The apparatus according to claim 15, wherein said attributing arrangement is adapted to repeat the attributing until the identity of the individual is authenticated.

23. The apparatus according to claim 22, wherein said attributing arrangement is adapted to perform a gradual authentication of an identity claim of the individual via issuing a stream of cues over time, each of said cues being indicative of one or more user groups to which the individual belongs with a given degree of confidence.

24. The apparatus according to claim 22, wherein said attributing arrangement is adapted to perform a partial authentication of an identity claim of the individual via issuing a stream of cues over time, each of said cues being indicative of one or more user groups to which the individual belongs with a given degree of confidence.

25. The apparatus according to claim 15, wherein said attributing arrangement is adapted to perform at least a partial assessment of the identity of the individual via issuing a stream of cues over time, each of said cues being indicative of one or more user groups to which the individual belongs with a given degree of confidence.

26. The apparatus according to claim 25, wherein said attributing arrangement is adapted to perform real time data retrieval, wherein the issued cues are employed to narrow down a database to be searched.

27. The apparatus according to claim 25, wherein said attributing arrangement is adapted to perform real time discovery of the individual, wherein the issued cues are employed to narrow down user models which represent potential users to be scored.

28. The apparatus according to claim 25, wherein said attributing arrangement is adapted to perform real time authentication of the individual, wherein the issued cues are employed to narrow down relevant imposter models which represent potential false users.

29. A program storage device readable by machine, tangibly embodying a program of instructions executable by the machine to perform method steps for assessing the identity of an individual, said method comprising the steps of:
accepting input from an individual;
attributing at least one user group to the individual; and
repeating said attributing step until the identity of the individual is assessed.
